(19) United States
(12) Patent Application Publication
(10) Pub. No.: US 2009/0010554 A1
(43) Pub. Date: Jan. 8, 2009

(54) Method for Processing Image Data

(75) Inventor: Paavo Eskelinen, Oulu (FI)

Correspondence Address: CONNOLLY BOVE LODGE & HUTZ LLP, 1875 EYE STREET, N.W., SUITE 1100, WASHINGTON, DC, 20006, US

(73) Assignee: SANHILL OY, Oulu (FI)

(21) Appl. No.: 11/910,348

(22) PCT Filed: Feb. 1, 2006
(86) PCT No.: PCT/FI06/00028

§ 371 Date: Oct. 1, 2007

(30) Foreign Application Priority Data
Feb. 1, 2005 (FI) 20050113

(51) Int. Cl. G06K 9/36

(52) U.S. Cl. 382/238

(57) ABSTRACT

In the method for compressing image data, a main block and it's sub-blocks are selected for processing and all sub-block groups and, finally, the main block to be compressed are processed in a fixed order starting from the lowest level blocks, i.e. blocks of level 1, whereby at the same time the status function is formed which is a series of numerical or status values depending in a certain way on the content of all sub-blocks of the main block. The original information of the blocks indicated by the status function is compressed into a small amount of values arranged in a certain way, and when decoding the image data, the original information of said blocks may be recovered at least approximately. In the encoding of each block of level 1, a threshold value and a quantization step may be defined and adapted in relation to each other or independently so that the relationship between the size and quality of the compressed image is optimal. The solution reduces especially the need of computing power in encoding and decoding image data.

### FIELD OF THE INVENTION

The present invention deals with a method to handle information contained in an image and more specifically with a method to compress image data, whereby this method partitions the image data in separate blocks.

### BACKGROUND OF THE INVENTION

There are two main classes of methods to compress digital data.

1) lossless compressing methods, where the compressed data can be decompressed into an exact copy of the original data, and

2) lossy compressing methods, where the nature of the data to be compressed allows some parts of the data to be dropped out during the compression phase so that the copy of the original data reproduced by decompression is sufficient for its purpose.

Lossless compression methods are required for example, in text processing, where it is expected that a decompressed copy should be identical with the original text. These methods are also applied when a lossy method produces a series of numbers (an approximation of original data) suitable for more compression by some lossless method. In this case an exact copy of the number series is gained by lossless decompression. Well known representatives of these methods are RLE, Shannon-Fano, Huffman, arithmetic and LZW codecs and BMP, GIF, PNG and TIFF methods popular in image compression.

Lossy methods are frequently applied in voice and image compression. This is based on the way human audio and visual perception deals with entireties instead of structural analysis of information details. Commonly known such methods are GSM in mobile telephones for voice reproduction and JPEG deployed in digital image processing, the latter being also a base in MPEG algorithms used in video technology.

Most of the popular compression methods can be found in the following publications:

Darrel Hankerson, Greg A. Harris, Peter D. Johnson, Introduction to Information Theory and Data Compression, Second Edition, 2003, Chapman & Hall/CRC, ISBN 1584883138, and

Mark Nelson, Jean-Loup Gailly, The Data Compression Book, Second Edition, 1996, M&T Books, New York, ISBN 1558514341.

The best compression ratios are usually achieved by methods which require substantial processing power. Fractal and wavelet algorithms are examples of these kind.

In small relatively inexpensive mobile devices, like telephones, processor power is quite modest. Due to limits in data transmission availability and capacity of wireless networks it would be desirable to have as good as possible compression ratios in image data. Many commercially available mobile devices could reach 5-8 frames/sec with good image quality in video playing by using methods inherent in MPEG technology. However, video reproduction would often be unpleasantly jerky. In many other image compressing applications it would be an advantage to cope with less processing power.

### SUMMARY OF THE INVENTION

The purpose of the present invention is to implement a method for image coding and decoding, which could reduce the amount of calculations in image data processing and would therefore be applicable in producing higher video frame rates in inexpensive mobile devices with low processing power.

To achieve this purpose to compress digital image data, in which method the pixel values are digitized, the present invention provides a method in accordance with independent claim 1. The other claims define some embodiments of the method of the present invention.

According to the method described by the present invention substantial number of the pixels can be omitted in compressing the image by using the three essential parts of this method comprising the status function and two adaptive parameters, the threshold and the quantization step, the last two being associated with the undivided blocks of the lowest level pixel groups and further during decompression the image pixels can be restored using fewer calculations than what are needed by present compression methods like for example, the MPEG technique. Status function values embedded in the compressed data are in the preferred embodiment in a highly compressed, for example, in binary number form, which consists of a series of numbers one and zero, and density of the two adaptive parameters compared to the pixel density of the image is very low.

Having only moderate processing power available it may still be possible to reach natural video reproducing rates of 15-25 frames/sec, which would render a pleasant viewing experience.

Neither the size nor the shape of an image part to be compressed, which is referred to as a “main block” later in this application, has practically no influence to the number of calculations per pixel. An approximation of any block can be produced, for example, as a set of approximate differences between the median of the pixel values and the pixel values.

### BRIEF DESCRIPTION OF THE DRAWINGS

The present invention together with some of its embodiments will be addressed in the following pages in more detail with reference to the accompanying drawings, wherein

FIGS. 1-3 illustrate schematic examples of a main block and its partition into sub-blocks at separate levels in accordance with method described in the present invention,

FIGS. 4-6 illustrate additional schematic examples of a main block and its partition into sub-blocks,

FIGS. 7A, 7B and 8 represent schematic examples of image encoding in accordance with the method described in the present invention,

FIGS. 9A and 9B show exemplary schematic diagrams of image decoding corresponding to the encoding processes of FIGS. 7A, 7B and 8 and

FIGS. 10-13 represent a schematic example of partitioning a main block of a 3-dimensional image into sub-blocks.

### DETAILED DESCRIPTION OF THE INVENTION

The source of image data to be handled by the method described herein may be, for example, a digitized image, an approximation of a digitized image, a difference of two digitized images or an approximation of a difference of two digitized images.

The basis for encoding an image or a difference of two images is the partition of the image into proper partial images or main blocks. These main blocks can represent plane or higher dimensional figures or images with variable sizes and forms. Algorithms used in calculations do not depend on the block structure. Hence a main block may consist of various groups with arbitrary number of pixels.

Generally speaking the method of the present invention an image may be partitioned into main blocks and sub-blocks so that a main block is defined to belong to the highest block level or it is an N level block, which comprises a group of lower level or N−1 level blocks, which are thus the sub-blocks of the main block. Each level N−1 block consists of a group of level N−2 blocks, which are consequently the sub-blocks of the corresponding level N−1 block, and so forth, until the level 2 is reached, where each block contains a group of level 1 blocks, which are no more partitioned and each of which forms a group of 1 or more pixels.

Generally speaking it may be advantageous to partition an image into main blocks having common borders with the image and between themselves, and similarly arranging the sub-blocks of a main block and so forth. Main blocks may also be structured with sub-blocks having no common borders.

The last unpartitioned sub-blocks may be formed, for example, by selecting pixels near by each other having their distribution of values to be limited to some suitable narrow range.

It is presumed that any pixel of an image belongs to some main block and any pixel contained in a main block is part of some sub-block of the main block.

The largest possible main block in a single image case is the image itself, or on the other hand, a series of video frames can be laid out on a plane to form a single image, a meta image, in which case the largest main block would be the video frames. A main block may thus consist of an arbitrary number images, which together form a single plane object, so that some images may or may not have common borders.

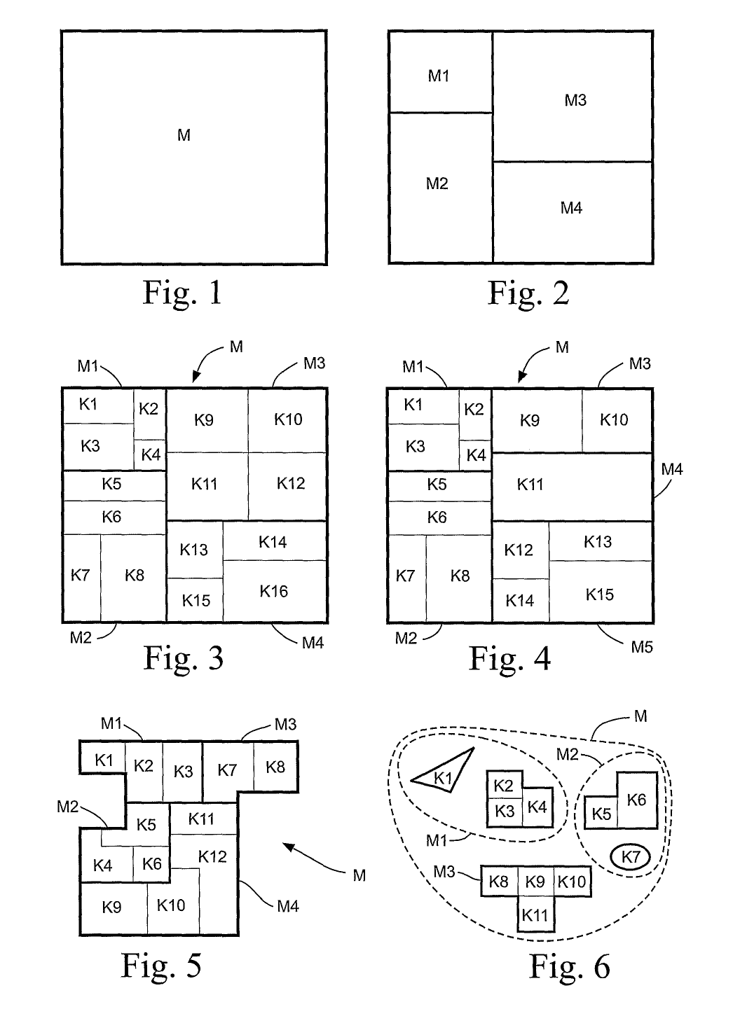

FIGS. 1-3 show an example of partitioning a square main block M first into four different size sub-blocks M1, M2, M3 and M4, each of which has then been partitioned into four different size undivided sub-blocks. M1 is formed by the sub-blocks K1, K2, K3 and K4, M2 is represented by the group of K5, K6, K7 and K8, M3 consists of K9, K10, K11 and K12 and M4 is defined by the sub-blocks K13, K14, K15 and K16. In this case there are three block levels: the highest level has the main block M, the next level (level 2) contains the four sub-blocks M1, M2, M3 and M4 of the main block, and finally, each of these sub-blocks consists of a group of level 1 blocks that remain unpartitioned. The smallest possible sub-block is naturally formed by one pixel.

FIGS. 4-6 illustrate cases where three main blocks have been divided into various sub-blocks.

FIG. 4 has five level 2 blocks M1-M5. Of these M1, M2 and M5 each holds a group of four level 1 blocks: K1, K2, K3,K4, then K5, K6, K7,K8; and finally K12, K13, K14, K15. The block M3 contains two level 1 blocks, K9 and K10, and the block M4 has only one level 1 block, K11.

FIG. 5 represents an example of a main block M with irregular shape, which has first been subdivided into four different size and shape level 2 blocks M1, M2, M3 and M4, which in turn consist of groups of various size and shape level 1 blocks, respectively: K1,K2,K3; and K4,K5,K6, and K7,K8; and K9, K10, K11,K12.

FIG. 6 shows a more general main block structure, in which the main block is fragmented and consists logically of three level 2 blocks M1, M2 and M3, which do not have any common borders at all. Two of the sub-blocks, M1 and M2 are formed by level 1 blocks K1, K2, K3,K4, and K5, K6,K7, which are partially fragmented.

The following exemplary embodiments of the method of the present invention deals only with a one component pixel. In processing colour images the method presented herein would then be applied separately to each pixel component. Depending on the application pixel values might refer to R, G and B components, or to colour palette indices, or to luminance and crominance, or to C, M, Y and K components, or to alpha values, or to spot colour indices.

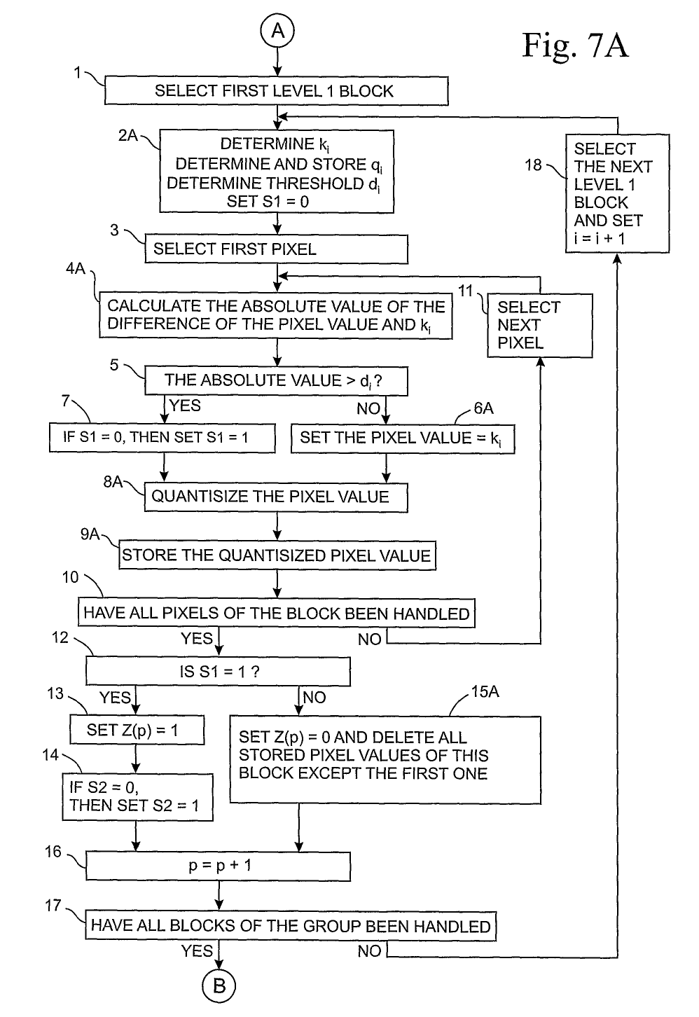

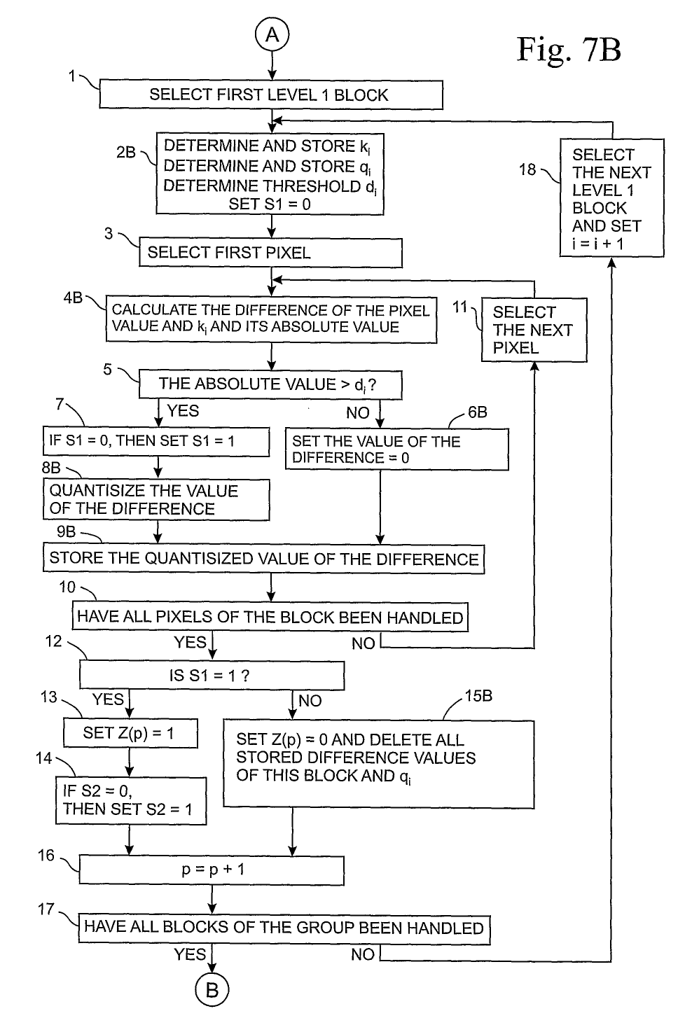

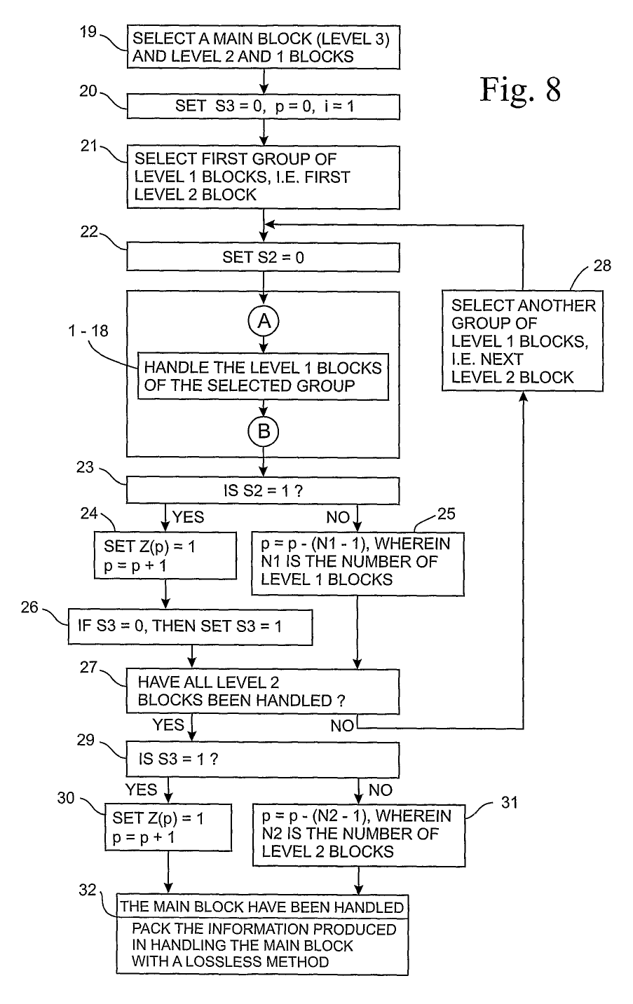

FIGS. 7A and 8 and correspondingly 7B and 8 show two exemplary embodiments of encoding the main block in accordance with the method of the present invention. The two cases differ from each other the following way: in FIG. 7A the actual pixel values are being processed, but the example illustrated in FIG. 7B deals with the differences between the pixel values and the parameters kᵢ representing the respective pixel groups. The main block in both cases belong to level 3. Two optional approaches to handle the level 1 blocks is presented with reference to FIGS. 7A and 7B. One essential feature of the method of the present invention is construction of the status function in a general image case simultaneously as the main block is being processed starting with level 1 block pixels and then proceeding to the next upper level until the entire main block has been dealt with. Another essential feature of the method of the present invention is defining during the encoding process the values of the two parameters that substantially affect the construction of the status function. These parameters are adaptive, which means that they depend on the geometric property of the level 1 block, the number and the values of the pixels contained in the block and the type of the pixel component.

One of the parameters contains the value of the threshold dᵢ and the other parameter defines the value of the quantization step qᵢ in such a way that the threshold value is always equal or greater than the quantization step. If the geometric property of a level 1 block is a 1-dimensional line, which has only slight luminance or chrominance variations, then it might be more advantageous to use constant values for the parameters regardless of the line length and maintain smooth quality.

In case a level 1 block is a 2-dimensional area, it might be better from the image quality point of view to use smaller threshold values for larger areas. On the other hand the distribution of pixel values can be allowed to affect the threshold value in order to have a certain percent of the pixel values or pixel difference values (e.g. deviations from the mean value) of the block define a threshold to be set.

Let us assume the situation of FIG. 7B. If one level 1 block includes e.g. 5 and another level 1 block 30 pixels, and if luminance pixel is concerned, then in the first case a suitable threshold value (e.g. 7) can be used and in the latter case that value of the distribution of the differences below which e.g. 25 percent of all values are. It is often possible to assign greater threshold values to the chrominance components than to the luminance ones.

The same criteria can be applied in determining the quantization step value, but additionally so that this parameter may depend directly on the maximum value or difference value of the level 1 block pixel components if e.g. the number of pixels is small and some values differ significantly from the other.

These parameter selections affect on one hand the bit amount of the status function and on the other hand the distribution of the quant values, i.e. the final compression efficiency which may be achieved for an image.

By applying these guidelines it is possible to achieve an optimum balance between the compression ratio and the image quality.

By deploying the status function data contained in the pixel approximate values or in the lossless case in the original pixel values can almost in all cases compressed into a new but smaller set of data, the amount of which can further be reduced by using some additional lossless compression method.

To start defining the status function each level 1 block is assigned a parameter, which may, for example, be an average or a median or some other value representing the block pixels, and to which each pixel value can be compared. These parameters are associated with the level 1 blocks K1, K2, K3, . . . and are referred to by k₁, k₂, k₃, . . . respectively.

The main block status function Z is assigned an argument p, which is an integer. The value of Z(p) is for all values of p a binary number 1 or 0. In practice the status function values would refer to a some part of a device memory, where the relative location of each value could be identified by p.

Actual processing of the main block may be done using logic ICs or software or both.

Encoding the main block is started in the first group of level 1 blocks forming a level 2 block. Each level 1 block is processed in some predefined order. All the sub-block groups forming all the level 2 blocks are processed respectively before proceeding into the next higher block level, where all the blocks are then processed in orderly fashion before proceeding again into the next higher block level and so forth, until reaching the highest block level, the main block.

FIGS. 7A and 7B illustrate the pixel quantization and forming of the status function Z (p) for an unpartitioned group of sub-blocks. To start processing the very first level 1 block in the level 1 block groups belonging to a main block, the argument p is assigned some initial value, for example zero.

In the following examples in forming the status function additional binary variables S1, S2 and S3 are used to define consecutive values of the status function. The number of these variables is always the same as the number of block levels. In starting to process any level 1 block the respective variable is set, S1=0. Then starting to process any level 2 block the variable S2 is set, S2=0. Here the main block is a level 3 block, and hence starting to process this block S3=0 is set.

In FIG. 8 after having initialized the variable S3, argument p and index i (phase 20) the first level 2 block, which contains level 1 blocks, is selected (phase 21). After this S2=0 is set (phase 22) and focus will be transferred on phases 1-18 either in FIG. 7A or 7B, where each level 1 block of the selected level 2 block will be processed one at a time.

The following will explain the FIG. 7A option. After the first level 1 block has been chosen (phase 1), the four parameters required in processing its pixels are initialized:

kᵢ, the value of which represents all the pixels at this level, and which can be assigned a value without any calculations or its value may be calculated based on the pixel values in this block, for example, as the average pixel value,

dᵢ, the threshold, the value of which is used as a reference, which the absolute difference between each pixel and kᵢ is compared to, and which may be the same or different for all the level 1 blocks,

qᵢ, the quantization step, the value of which is used for quantization, and which may be the same or different for all the level 1 blocks,

S1, the value of which is set to zero.

The index i, the subscript of the parameters kᵢ, dᵢ and qᵢ, is an integer, which refers to the number of the level 1 block being processed.

After the level 1 block initialization process has been completed each pixel starting with the first one (phase 3) in this block will be processed: first (phase 4A) the absolute difference of the values of the pixel and the parameter kᵢ are calculated, this value is then (phase 5) compared to the value of the parameter dᵢ. If the absolute difference value is less or equal to dᵢ then the pixel value will be replaced by the kᵢ value (phase 6A). In case the absolute difference is greater than dᵢ and if the variable S1=0, then S1=1 is set (phase 8A). In both cases processing continues to phase 8A, where the pixel quantization will be performed using the value of qᵢ. Quantization is achieved by dividing the pixel value by the qᵢ value, rounding the result to the nearest integer and then assigning the pixel this new value. The pixel quantum value is stored (phase 9A) and then (phase 10) it is checked if all the pixels have been dealt with. If there are still pixels left, the next pixel in turn is chosen and it is processed starting at phase 4A.

After processing of all the pixels have been completed the value of S1 is checked (phase 12). If this value is 1 then the status function will be assigned this value (phase 13) using the current argument value, so that Z(p)=1. Now (phase 14) the value of S2 is checked, and if this is 0 it will be changed to 1. Otherwise, processing will continue from phase 12 to phase 15A, where the status function value is set to zero, so that Z(p)=0, and consequently all these previously stored pixel values except the first one are removed from the memory. Once the status function value has been stored the argument p value is incremented by 1 (phase 16). A check is performed (phase 17) to see if all the level 1 blocks have been processed, and if not so, then the index i is incremented by 1 and the next level 1 block is chosen to be handled starting at phase 2A.

The differences in the alternative approach presented in FIG. 7B compared to FIG. 7A are as follows. The value of kᵢ is also stored (phase 2B) for each level 1 block processed, which results in storing a series of values . . . kᵢ₋₁, kᵢ, kᵢ₊₁ . . . .

At phase 4B both the difference of the pixel and the parameter kᵢ value and the absolute difference is calculated. If the absolute difference is less or equal to dᵢ then the difference value is (phase 6B) set to zero, which is then also the quantum value of the difference. Otherwise, if S1 is 0 it is set to 1 (phase 7), and then the difference is quantizised (phase 8B). The quantum difference is then stored (phase 9B). After S1 has been checked (phase 12) and found to zero, the status function is assigned (phase 15B) a value zero, Z(p)=0, and all the stored difference values together with the kᵢ and qᵢ values associated with this level 1 block are removed from the memory.

After handling of all the level 1 blocks of the current level 2 block is completed processing continues in accordance with the diagram presented in FIG. 8, and next the variable S2 value is checked (phase 23). If the value is 1, then the status function value is set to 1 (phase 24) with the current argument value p and p is incremented by 1. If the variable S3 is equal to 0, its value is changed to 1 (phase 26).

If the value of S2 is 0, the argument p value is decreased by N1−1 (phase 25), where N1 equals to number of level 1 blocks.

After this it is checked (phase 27) if all the level 2 blocks have been processed, and if not, then the next level 2 block is selected (phase 28), which contains the next group of sub-blocks of the current block. Now processing the group continues as described above starting at phase 22.

After handling of all the level 2 blocks is finished, processing focus is transferred on level 3 blocks, which there are in this case only one, the main block. At phase 29 the value of S3 is checked. If the value is 1, then the status function value is set to 1 using the current p value and p is incremented by 1, and now the p value indicates the total number of status function values. If the S3 value is 0, the p value is decremented by N2-1, where N2 equals to number of level 2 blocks. Also in this case p contains the total number of status function values.

This completes the encoding process of the main block in accordance with the method of the present invention, which it is indicated in the diagram of FIG. 8 (phase 32). The pixel quantum values together with the kᵢ values or alternatively the quantum difference values together with the level 1 block parameters kᵢ and qᵢ or the differences in the two parameters and in some cases also the status function values and the geometric properties of different main blocks can still be compressed by means of some lossless method to minimize the size of the compressed data. This is usually the case in practical applications.

It is possible to reduce significantly the amount of data required to represent an approximation of an image besides quantization of the pixel values by generating a status function during the encoding process using adaptive parameters in cases where the additional data load due to status function values is moderate and when the status function is able to replace main block pixel groups with their respective values of kᵢ or approximations of kᵢ. Any status function value would reserve only one bit of memory.

Encoding of video frames can yield even greater data reduction. The frame main blocks may be geometrically identical, in which case the structural information (the number of block levels, the number and the location and the shape of sub-blocks) is stored only once.

Another essential advantage of the method of the present invention is the small amount of calculations required, particularly when compared to techniques using mathematical transformations. During the decoding process the amount of calculations can be reduced more as several groups of approximate pixel values may be reconstructed by simply assignment operations. Decoding of video frames may also allow groups of pixels to be ignored, which further decreases the required processing power.

The status function is composed of an organized series of binary numbers 0 and 1, for example { . . . 1000101110 . . . }. The pixel approximate values consist of two organized series of integers, where the first contains the pixel quantum values (x), for example { . . . x₄ x₅ x₆ x₇ . . . }, and the second represents the quantization steps { . . . q₂ q₃ q₄ . . . }, or alternatively there are three organized series of integers: the difference quantum values (e), for example { . . . e₄ e₅ e₆ . . . }, representing the differences between the pixel values of groups and the respective group parameters kᵢ, for example { . . . k₃ k₄ k₅ . . . }, and the quantization step values { . . . q₃ q₄ q₅ . . . }.

Decoding an image is accomplished by decoding each main block.

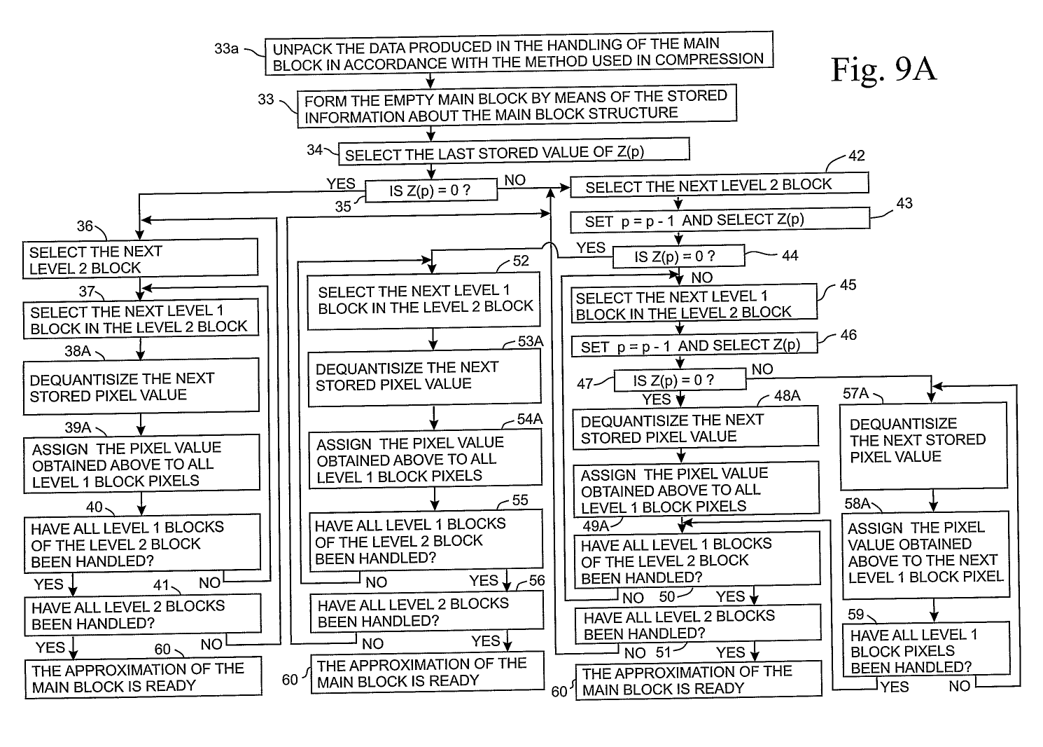

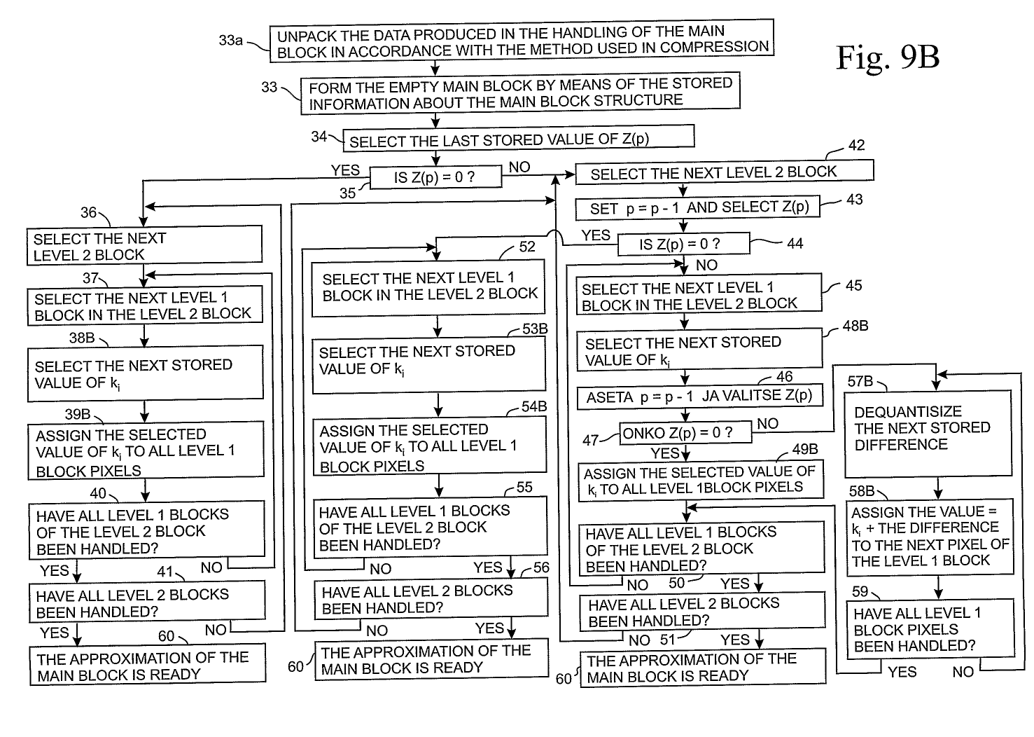

The main block decoding, which is the inverse process of the encoding, is shown in FIGS. 9A and 9B with the respective encoding in FIGS. 7A and 7B. Before the actual decoding all data is first decompressed with the pertinent lossless method (phase 33a). At phase 33 the main block structure is first reconstructed in the memory using information stored during the encoding process and free space enough to store all the main block pixel values is allocated in the memory. Decoding is now performed by reading the status function values, the handling order of the sub-blocks and the values associated with the approximate pixel values in reverse order, that is, the last stored value is read first and so forth, until the first stored value is reached. The expression “next” in FIGS. 9A and 9B refers thus to the value before the current one.

Decoding the main block is commenced by reading the last value of the status function If it is 0, then it is the only value existing in the status function, and the values of all the pixels in the main block are reconstructed following the left branch (phases 3641) in FIGS. 9A and 9B. All the blocks of the levels 2 and 1 as well as all the level 1 pixels are processed in predefined order (phases 36, 37, 40 and 41). In the case of FIG. 9A the next stored pixel quantum value is selected (phase 38A) and then by dequantization the pixel value is reconstructed. These quantum values form the series of the approximate pixel values, which were calculated during the encoding process, and which are now read in reverse order. The pixel value decoded at phase 39A is assigned to all the main block pixel values.

In the case of FIG. 9B the next kᵢ value is gained (phase 38B) by reading the previously stored parameter series in reverse order and by dequantization it if it was quantizised. This value is then assigned to all the main block pixel values (phase 39B).

It is then checked (phase 40) if all the sub-blocks of the current level 2 block have been processed. If not, processing returns to phase 37. If all the sub-blocks have been processed, then it is checked (phase 40) if all the level 2 blocks have been dealt with. If not, then processing returns to phase 36. If all the level 2 blocks have been processed then the main block decoding is complete and the approximation of the main block is ready (phase 60), or in the case of lossless compression the original main block.

If the last status function value is 1 then processing of the last encoded level 2 block is started (phase 42). Now the next status function value is read (phases 43 and 44). If it is 0, processing continues to phases 52-56, where the next level 1 block of the current level 2 block (phase 52) is selected, and from phase 55 processing returns to phase 52 if all the level 1 blocks have not been dealt with. If all have been processed, then a check is performed (phase 42) to see if all the level 2 blocks have been handled, and if not, processing is returned to phase 42.

In the case of FIG. 9A all the level 1 blocks of the current level 2 block are handled is first by reading and dequantizising the next pixel quantum value and then assigning this value to all the level 1 block pixels (phase 54) according to the way of phase 38A and 39A.

As to FIG. 9B the next kᵢ value is selected by reading, and possibly dequantizising, the previously stored parameter value series in reverse order. This value (phase 54B) is then assigned to all the level 1 block pixels.

Again a check is performed (phase 55) to see if all the level 1 blocks of the current level 2 blocks have been dealt with. If not, processing returns to phase 52. Otherwise, another check is performed (phase 56) to see if all the level 2 blocks have been handled. If not, processing returns to phase 42. Otherwise, the main block decoding is complete and an approximation of the main block is ready (phase 60).

If the status function value (phase 43) is 1, the last encoded level 1 block is examined (phase 45). In FIG. 9A the next status function value is read (phases 46 and 47). If it is 0, then processing the next level 1 block proceeds (phases 48A and 49A) the same way that was described concerning the phases 38A, 39A and 53A, 54A, and accordingly all the level 1 block pixels are assigned their values.

In the case of FIG. 9B after phase 45 the next parameter kᵢ in the number series is read (phase 45B). After this processing proceeds to phases 46 an 47 as described above, and in case the status function value is 0 all the pixels in the level 1 block are assigned this kᵢ value.

If the status function value is now 1 (phase 47), then as shown in FIG. 9A each level 1 block is processed as follows (phases 57A, 58A and 59): the next pixel quantum value is read and dequantizised and then this value is assigned to the level 1 block pixel respectively until all the values have been handled. After this processing continues to phase 50. Accordingly in FIG. 9B each pixel approximate value is retrieved by first reading the number series of quantum differences in reverse order, then dequantizising the read value (phase 57B), and then assigning each level 1 block pixel the sum of this value and the kᵢ value (phase 58B). As long as there pixels still unassigned processing returns to phase 57B, otherwise, it proceeds to phase 50.

Then it is checked (phase 50) if all the level 1 blocks of the current level 2 block have been handled. If not, then processing returns to phase 42. Otherwise, the main block decoding is complete and the approximation of the main block is ready (phase 60).

Above an embodiment of the method of the present invention was described, where the two status function values were 0 and 1. This is the preferred embodiment because this would require the least amount of transmission and storage capacity regarding the status function. Other values are also applicable, for example, these values could be composed of 2 bits each, or they might be expressed by, for example, the values of Q and T, which would carry the same information as the binary values 0 and 1. It is also possible to have more than two separate values of the status function, in which case they could contain additional information embedded in the sub-blocks.

Another possible embodiment of the method of the present invention will be explained next phase by phase. In this method to compress image data the digital values (for example, pixel values) are encoded to reduce the amount data representing the original image in either a lossy or lossless way, and the method comprises the following stages:

1) the image data is partitioned into suitable size main blocks, each of which may contain either the same or different amount of digital values of the image data.

2) each main block to be compressed and the smaller sub-blocks of the main block are chosen so that the main block to be compressed is called a level N, or the highest level, block, which consists of a group of sub-blocks belonging to the next lower level N−1, and, in turn, each of the level N−1 blocks consists of a group of sub-blocks on the next lower level N−2, and so forth, until the level 2 is reached, the blocks of which contain groups of sub-blocks on the level 1, where the blocks have no sub-blocks any more, and thus if the main block level happens to be 1 then it is also the smallest sub-block and there is only one block,

3) all the sub-blocks and finally the main block to be compressed are handled in an organized manner, so that processing starts with the level 1 blocks and simultaneously the status function is formed, the status function being a series of numbers depending on the content of all the sub-blocks of the main block as follows:

3.1) each group of level 1 blocks belonging to a level 2 block is processed in the way that the status function is given serially a number Q or T right after the previous number, so that this number is T, if any of the digital values of the said level 1 block deviates from the value (ki) assigned to the said level 1 block by more than the other assigned value (di), then the said digital value or its approximate value or the difference between the digital value and ki or the approximate value of this difference, and in case additionally performing quantization, the respective quantization step value, are stored in the main block encoding data in orderly fashion, otherwise, the status function is given the number Q, which indicates that all the digital values of the said level 1 block are assigned the same value ki or an approximation of ki, which is then stored in the main block encoding data in orderly fashion, and all the said digital values previously stored are removed,

3.2) after all the said level 1 blocks of a group have been processed the status function is given at this point the number T if the status function was given the number T while any of the said level 1 blocks was handled, otherwise, all the numbers Q that were assigned to the status function while this group was processed are replaced by one number Q, which now indicates that all the digital values of the first said level 1 block of the group are assigned the same value ki or its approximate value, and that all the digital values of the second said level 1 block of the group are assigned the same value ki+1 or its approximate value, and that all the digital values of the third said level 1 block of the group are assigned the same value ki+2 or its approximate value, and so forth up to the last said level 1 block, the digital values of which are assigned the same value ki+L1−1 or its approximate value, where L1 equals to the number level 1 blocks of the said group, and

3.3) after this, each time the next higher level J is addressed, every block of the next higher level J is handled so that each group of the lower level J−1 blocks belonging to the higher level J is dealt with as follows: the status function is given the number T for each said lower level group if the status function was given the number T for any of the blocks of the said lower level group, otherwise, the numbers Q representing the blocks of the said lower level group are replaced by a single number Q, which indicates that the number of level 1 blocks, the digital values of which are all assigned the same value representing the block, is J1, which is the number of such level 1 blocks which are associated with the same number of values or approximate values given by the series ki, ki+1, ki+2 . . . , ki+J1−1,

4) all the data gathered and stored during the procedure described above are then compressed by means of some appropriate lossless method, like for example, the Huffman encoding,

5) each ki value or approximate value represents all the digital values of a level 1 block, and hence these digital values are no longer contained in the compressed form of the image data,

6) the compressed data includes information about the structures of all the sub-blocks of the main blocks, or in case the main blocks are all identical only the structural information of one main block is included, and

7) during the decoding process the status function in combination with the structural and order data of the sub-blocks assigns the digital values retrieved to the proper locations in the sub-blocks.

In the previous exemplary embodiments the method of the present invention was applied to process data of 2-dimensional images. The method of the present invention can equally well be deployed in cases which, for example, deal with 3-dimesional images.

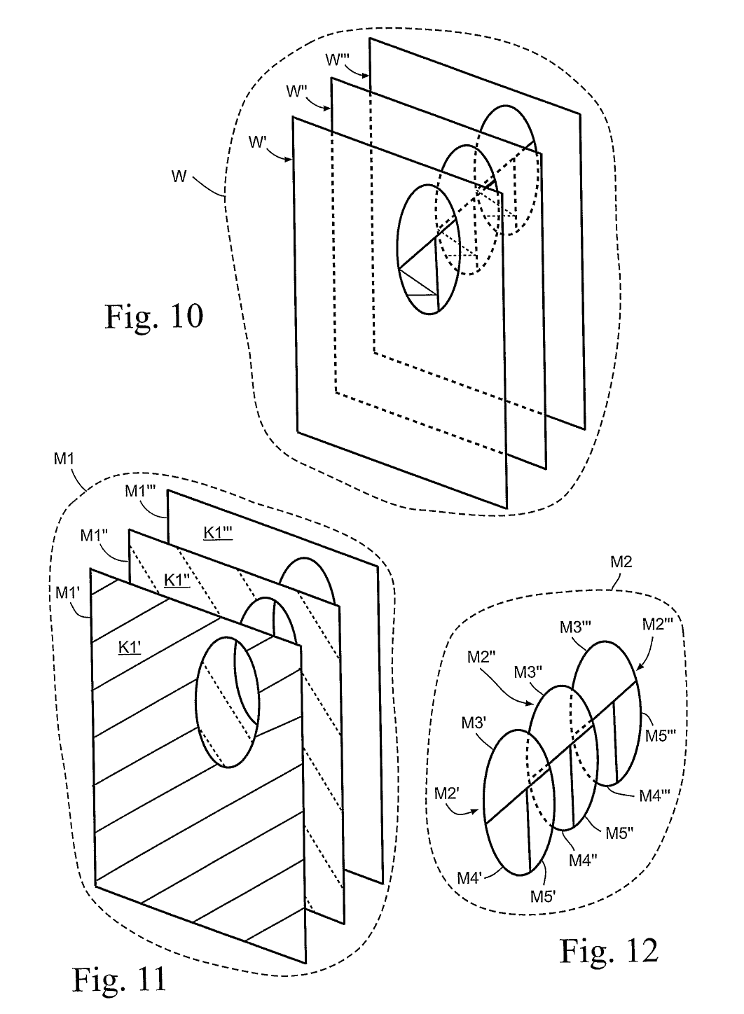

FIGS. 10-13 illustrate an example of a 3-dimesional image, where the image data is partitioned into the main block and its sub-blocks in order to apply the method. In FIG. 10 is an exemplary 3-dimensional image W, which consists of the three plane images W, W″ and W′″. A three dimensional image has at least two plane images, the number of which has naturally no upper limit. This kind of an image may be composed for example, of a series of video frames or their differences, or it can be an approximation of a 3-dimensional image achieved by a group of plane images.

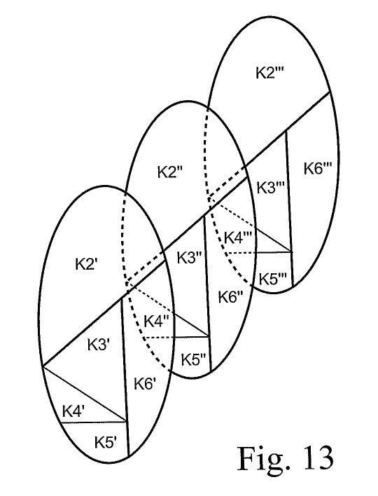

In the example given in FIG. 10 the main block and all the sub-blocks are three dimensional. The main block comprises the entire 3-dimensional image, thus W={W′ W″ W′″}. The main on the highest level 4 has been divided into two sub-blocks on the level 3. The first sub-block M1 is shown in FIG. 11, where M1={M1′ M1″ M′″}, and the second sub-block M2 is shown in FIG. 12, where M2={M2′ M2″ M2′″}. Of these two the block M2 is unpartitioned, that is, it has only one sub-block, thus M1={K1}, where K1={K1′ K1″ K′″}.

In FIG. 12 the other level 3 block M2 has been partitioned into three sub-blocks, that is, the level 2 blocks M3={M3′ M3″ M3′″}, M4={M4′ M4″ M4′″} and M5={M5′ M5″ M5′″}.

FIG. 13 displays all the unpartitioned, that is, level 1 blocks. As shown the block M2 is unpartitioned so it has only one sub-block, thus M2={K2}, where 2={K2′ K2″ K2′″}. The next block M3 holds three level 1 sub-blocks, in other words, M3={K3 K4 K5}, where K3={K3′ K3″ K3′″}, K4={K4′ K4″ K4′″} and K5={K5′ K5″ K5′″}. The last level 3 block M5 is also unpartitioned and so M5={K6}, where K6={K6′ K6″ K6′″}.

In the above example of FIG. 10 the plane sub-blocks forming the three dimensional sub-blocks share the same coordinates from one plane to another, but they may also occupy different relative locations from each other from plane to plane.

Also in the case of a three dimensional image a parameter ki value always represents an unpartitioned level 1 block, where the value is either preset or it is calculated based on all the digital values of the level 1 block as an average or median value. The other parameter di may be different for each level 1 block, or one single value could be assigned to all the level 1 blocks.

Processing of the main block and construction of the status function is analogous to what has been presented in the plane image case.

The main block may comprise any number of images which together define a three dimensional image, or it may be a three dimensional image. The main block may contain any number of three dimensional images, so that some of the images may share common borders or that they have no common borders.

The main block may also be composed of a number of three dimensional images forming together a four dimensional image.

The term “pixel” is used in this application in accordance with its original meaning (picture element) to refer to elements of an image also in case where there are three or more dimensions in the image. Correspondingly the term “pixel value” may be used to indicate all the possible image elements that the image data could contain.

The method of the present invention is not limited to the embodiments described above. For example, construction of the status function and the processing order of some of the phases may be accomplished in manners different from the ones explained in the previous text.

The previous examples described in more detail handle cases with unquantizised pixel values, but as some parts of the text indicate the method is applicable to quantum image data as well.

There can be other specific forms of the present invention without departing from the essential characteristics thereof.

What is claimed is:

1. A method for compressing image data in which method the image data is partitioned into blocks for processing, characterized in that therein:
a main block and sub-blocks are selected for processing so that the main block is a level N block formed by a group of sub-blocks which are lower level blocks, i.e. level N−1 blocks, which in turn are lower level blocks, i.e. level N−2 blocks, and so on, so that finally level 2 blocks are each formed by a group of undivided level 1 blocks, whereby each group includes one or more sub-blocks and each level 1 block includes one or more pixels;
all groups of sub-blocks and finally the main block to be compressed are processed in a certain order starting from the level 1 blocks and at the same time a status function is formed which is a series of numeric or status values depending on a certain manner on the contents of all sub-blocks as follows:
the group of level 1 blocks is processed so that for each level 1 block it is determined if pixel values included in it are the same or replaceable by some single pixel value, and if so, value Q is written to the status function, and if not so, value T is written to the status function, and after all the level 1 blocks included in said group have been processed, one additional T value is written to the status function if for any level 1 block of said group the T value was written to the status function and otherwise the Q values corresponding to the level 1 blocks of said group are replaced in the status function by one Q value;
the group of level 2 or higher level sub-blocks is processed so that representing the group one T value is added to the status function if for any sub-block included in the group T value was written to the status function and otherwise the Q values corresponding to the sub-blocks of said group are replaced by one Q value;
whereby the original information of the blocks indicated by the Q values of the status function is compressed into a small amount of values arranged in a certain manner and, when encoding the compressed image data, the original information of said blocks may be recovered at least approximately by the status function, said values arranged in some preset manner and information concerning the block partition and the block processing order.

2. A method for compressing image data according to claim 1, characterized in that the Q and T values to be written to the status function are 0 and 1, respectively.

3. A method for compressing image data according to claim 1, characterized in that when processing a group of level 1 blocks it is determined if any of the pixel values of the level 1 block under processing differs from a first value (kᵢ) set for the level 1 block concerned more than a second value (dᵢ), i.e. threshold value, set for said level 1 block, and if so, the T value is written to the status function and the values corresponding to the pixel values are included in the compressed data, and if not, the Q value is written to the status function and all the pixel values of the level 1 block concerned are deleted from the compressed data and the information about the value to be given to all the pixels of level 1 block concerned is included in a certain position in the compressed data.

4. A method for compressing image data according to claim 3, characterized in that the value corresponding to the pixel value to be included in the compressed data is the pixel value itself or its approximation or the difference or the approximation of the difference of the pixel value and said first value (kᵢ).

5. A method for compressing image data according to claim 3, characterized in that the information about the value to be given to all the pixels of level 1 block concerned is said first value (kᵢ) or its approximation.

6. A method for compressing image data according to claim 3, characterized in that the first value (kᵢ) set is zero.

7. A method for compressing image data according to claim 3, characterized in that the threshold value (dᵢ) set is zero.

8. A method for compressing image data according to claim 3, characterized in that when processing any of level 1 blocks a quantization step (qᵢ) is determined for quantization of the value corresponding to the pixel value or the value given to all the pixels whereby the quantization step and the threshold value (dᵢ) may be determined adaptively according to the geometric shape, the number of pixels included in said block and/or distribution and/or magnitude and/or the type of the pixel component under encoding.

9. A method for compressing image data according to claim 8, characterized in that the threshold value (dᵢ) and the quantization step (qᵢ) are determined and adapted in relation to each other so that the relation between the size of the package and the quality of the image is optimal.

10. A method for compressing image data according to claim 1, characterized in that the main block includes a defined suitable part of an image.

11. A method for compressing image data according to claim 10, characterized in that an image is divided for processing into main blocks similar with each other.

12. A method for compressing image data according to claim 10, characterized in that an image is divided for processing into main blocks different from each other.

13. A method for compressing image data according to claim 1, characterized in that the main block includes an image as a whole.

14. A method for compressing image data according to claim 1, characterized in that the encoded image data is additionally compressed with a suitable lossless method.
